(19) United States
(12) Patent Application Publication
(10) Pub. No.: US 2007/0296125 A1
(43) Pub. Date: Dec. 27, 2007

(54) Thin cuff for use with medical tubing and method and apparatus for making the same

(76) Inventors: Joel Colburn, Walnut Creek, CA (US); Roger Caluya, Fremont, CA (US)

Correspondence Address: Nellcor Puritan Bennett LLC;c/o Fletcher Yoder PC, P.O. BOX 692289, HOUSTON, TX, 77269-2289, US

(21) Appl. No.: 11/473,285

(22) Filed: Jun. 22, 2006

(51) Int. Cl. B29C 39/14

(52) U.S. Cl. 264/562

(57) ABSTRACT

A method of manufacturing an inflatable cuff is provided. The method includes the acts of stretching a tube, creating a positive pressure within the tube, changing the amount the tube is stretched, heating the tube, and increasing the positive pressure within the tube such that a portion of the tube in blown outward to form a cuff.

### BACKGROUND OF THE INVENTION

1. Field of the Invention

The present invention relates to medical devices, and more particularly, to tracheal tubes and other tubes designed to form a seal against a surrounding passage.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

In the course of treating a patient, a tube or other medical device may be used to control the flow of air, food, fluids, or other substances into the patient. For example, medical devices such as suction catheters, gastric feeding tubes, esophageal obturators, esophageal balloon catheters, oral and nasal airways, bronchoscopes, breathing circuits, filters, heat and moisture exchanges, and humidifiers may be used to control the flow of one or more substances into or out of a patient. In many instances it is desirable to provide a seal between the outside of the tube or device and the interior of the passage in which the tube or device is inserted. In this way, substances can only flow through the passage via the tube or other medical device, allowing a medical practitioner to maintain control over the type and amount of substances flowing into and out of the patient.

For example, tracheal tubes may be used to control the flow of air or other gases through a patient's trachea. Such tracheal tubes may include endotracheal (ET) tubes or tracheostomy tubes. To seal these types of tracheal tubes, an inflatable cuff is typically employed. In older tracheal tubes, the inflatable cuff was often low volume, high pressure (LVHP) cuff which, when expanded, pressed against the tracheal wall to the point where the tracheal wall might be deformed. More modern tubes, however, typically employ high volume, low pressure (HVLP) cuffs which generally conform to the size and shape of the trachea. In this manner, major air leaks during positive pressure ventilation, i.e., when air is being pushed into the lungs, and gas leaks during anesthesia procedures may be prevented.

However, to fit a range of trachea anatomies with a given size of tracheal tube, modern HVLP cuff diameters are usually about one and a half times the diameter of the trachea. Therefore, when inflated, the cuff hits the tracheal wall and folds in on itself at some locations. These folds may occur on the periphery of the inflated cuff, i.e., against the tracheal wall, or at an interior region or portion of the inflated cuff, i.e., not adjacent or proximate to the tracheal wall. These folds, whether on the periphery of the inflated cuff or inward from the periphery, may serve as conduits that allow microbe laden secretions to flow past the cuff and enter the lung.

In particular, a tracheal tube may provide a substrate upon which bacterial colonization can occur. Bacteria may be introduced via inhaled aerosols and nasal, oropharyngeal, and gastric secretions. When such bacteria form colonies they may form microbial adhesions or biofilms on the surfaces of the tracheal tube. These bacteria may be present in secretions that leak through the folds formed by the cuff along the tracheal wall. When such leakage occurs, it may be a factor in the development of ventilator-associated pneumonia (VAP) and/or other disorders. In turn the VAP or similar disorder may prolong hospitalization and/or ventilation and may add additional days to a patient's hospital stay, along with the associated expenses of such a stay.

One method of mitigating colonization of the tube surface by bacteria is by suctioning. Suctioning, aspirating, or draining subglottic secretions, however, requires the frequent intervention of a clinician in order to be effective. It would be desirable if the incidence of VAP could be reduced without requiring additional activities on the part of the clinician in order to be effective.

### SUMMARY

Certain aspects commensurate in scope with the originally claimed invention are set forth below. It should be understood that these aspects are presented merely to provide the reader with a brief summary of certain forms of the invention might take and that these aspects are not intended to limit the scope of the invention. Indeed, the invention may encompass a variety of aspects that may not be set forth below.

There is provided a method of manufacturing an inflatable cuff that includes: stretching a tube; creating a positive pressure within the tube; changing the amount the tube is stretched; heating the tube; and increasing the positive pressure within the tube such that a portion of the tube is blown outward to form a cuff.

There is provided a method of forming a tube for use in a cuff-manufacturing process that includes: heating at least a section of a tube to at a temperature greater than the melting point of the tube; stretching the tube in the direction of the main axis of the tube such that the heated section lengthens and thins; and providing the stretched tube as a substrate for forming at least one inflatable cuff, wherein the inflatable cuffs are formed from the section of the tube.

There is provided a method of manufacturing an inflatable cuff that includes: stretching a tube comprising a composition; creating a positive pressure within the tube; changing the amount the tube is stretched; heating the tube; and increasing the positive pressure within the tube such that a portion of the tube is blown outward to form a cuff comprising the composition, wherein the tensile strength of the composition is greater in the cuff than in the tube.

### BRIEF DESCRIPTION OF THE DRAWINGS

Advantages of the invention may become apparent upon reading the following detailed description and upon reference to the drawings in which:

FIG. 1 illustrates a tracheal tube, in accordance with aspects of the present technique;

FIG. 2 illustrates a tracheal tube deployed within a trachea, in accordance with aspects of the present technique;

FIGS. 3A-3D illustrate various configurations of an inflatable cuff for use with a tracheal tube, in accordance with aspects of the present technique;

FIG. 4A illustrates a tube and mold used in the manufacture of an inflatable cuff, in accordance with aspects of the present technique;

FIG. 4B illustrates the insertion of the tube into the mold of FIG. 4A, in accordance with aspects of the present technique;

FIG. 4C illustrates the stretching of the tube and the application of air pressure to the tube, in accordance with aspects of the present technique;

FIG. 4D illustrates the reduction of the stretch and the increase in air pressure applied to the tube, in accordance with aspects of the present technique;

FIG. 4E illustrates the application of heat to the tube, in accordance with aspects of the present technique;

FIG. 4F illustrates the tube being maintained at a desired temperature, in accordance with aspects of the present technique;

FIG. 4G illustrates the cooling of the tube and the application of a vacuum to the tube, in accordance with aspects of the present technique;

FIG. 4H illustrates the trimming of extraneous portions of the tube after removal from the mold apparatus to produce the cuff, in accordance with aspects of the present technique;

FIG. 5 illustrates a flow chart depicting acts for manufacturing an inflatable cuff, in accordance with aspects of the present technique;

FIG. 6A illustrates a front view of a spool of tube fed into a mold assembly, in accordance with aspects of the present technique;

FIG. 6B illustrates a side view of a spool of tube fed into a mold assembly, in accordance with aspects of the present technique;

FIG. 7A illustrates a tube used in the manufacture of an inflatable cuff, in accordance with aspects of the present technique;

FIG. 7B illustrates the tube of FIG. 7A being clamped and pulled, in accordance with aspects of the present technique; and

FIG. 7C illustrates the tube of FIG. 7B after application of heat and stretching, in accordance with aspects of the present technique.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

It is desirable to provide a tracheal tube or other medical device which can be effectively sealed against the passage in which the tube or device is inserted. In accordance with some aspects of the present technique, an ultrathin cuff is provided about a tracheal tube or other medical device. The ultrathin cuff, when inflated, forms folds against itself and/or the surrounding passage that are too small for microbe containing secretions to pass through. Further, the thinness of the cuff may also result in a cuff that is more readily deformable and which, therefore, forms a more conforming fit to the surface of the trachea or other passage, thereby producing a better seal.

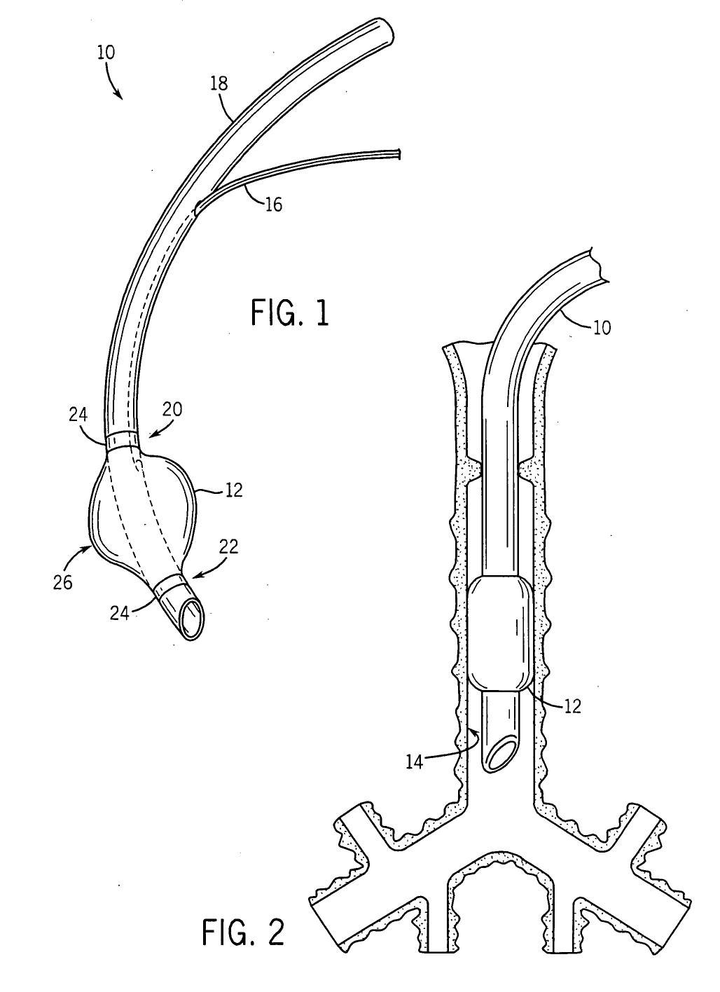

A variety of medical devices are designed to be inserted within cavities or passages of the human body. Examples of such medical devices include catheters, stents, feeding tubes, intravenous tubes, breathing tubes, and so forth. In many instances it is desirable that a seal be formed between the medical device and the surrounding passage or cavity. An example of such a medical device is an endotracheal tube 10, as depicted in FIG. 1. The endotracheal tube 10 includes an inflatable cuff 12 that may be inflated at low pressure (approximately 25 cm H₂O or less) to form a seal against the trachea wall 14 (see FIG. 2). Typically the inflatable cuff 12 is inflated and deflated via a tube 16 in communication with the inflatable cuff 12.

For simplicity, the present example describes the use of the inflatable cuff 12 in the context of an endotracheal tube. However, those of ordinary skill in the art will appreciate that the inflatable cuff 12 can be used with other medical devices, such as those listed above, or with devices in general which it is desirable to form a seal between the device and a surrounding passage or pathway. Therefore, it should be understood that the present examples and descriptions are merely exemplary and are not intended to limit the scope of the present technique.

Returning now to FIG. 1, in accordance with the present technique, the wall of the inflatable cuff 12 is about 0.001 inches (0.0254 mm) thick or less. In one embodiment, the wall of the inflatable cuff 12 is about 0.0004 inches (0.01016 mm) thick or less. In a further embodiment the wall of the inflatable cuff 12 is between about 0.0002 inches (0.00508 mm) thick and about 0.00015 inches (0.00381 mm) thick. In an additional embodiment, the wall of the inflatable cuff is about 0.0001 inches (0.00254 mm) thick. In addition, the walls of the inflatable cuff 12 are made of a material having suitable mechanical properties (such as puncture resistance, pin hole resistance, tensile strength), chemical properties (such as forming a suitable bond to the main tube body 18), and biocompatibility. For example, in one embodiment, the wall of the inflatable cuff has a puncture resistance of 7 pounds of force per square inch or greater.

In one embodiment, the walls of the inflatable cuff 12 are made of a polyurethane or polyurethane-based composition having suitable mechanical and chemical properties. An example of a suitable polyurethane is Dow Pellethane® 2363-90A. In other embodiments, the walls of the inflatable cuff 12 are made of other suitable polymeric compositions. Examples of suitable polymeric compositions include polymethylmethacrylate (PMMA), polyacrylonitrile (PAN), polyamide (such as nylon) (PA), polycarbonate (PC), polyesters (such as polyethylene terephthalate (PET)), polyolefins (such as polyethylenes (PE) and polypropylenes (PP)), polystyrene (PS) or vinyls (such as polyvinyl chloride (PVC) and polyvinylacetate). Other polymers and/or polymer admixtures having suitable mechanical, chemical, and biocompatibility properties may also be used to form the cuff 12.

In the embodiment depicted in FIG. 1, the cuff 12 is shaped as being generally curved at the ends and wider near the middle when inflated. As will be appreciated by those of ordinary skill in the art, the degree of curvature and/or linearity at different parts of the cuff 12 may vary. As depicted in the embodiment of FIG. 1, the cuff 12 may be secured at the proximate end 20 and distal end 22 to the main tube body 18, such as by collar regions 24 adhered, fused, or otherwise attached to the main tube body 18. However, the cuff body 26 between the proximate and distal ends 20 and 22 forms an expanded structure between these ends when partially or completely inflated. As depicted in FIG. 2, when inflated in the trachea, the inflated cuff 12 may be partially flattened, such as at the widest portion, to form a seal against the tracheal wall 14.

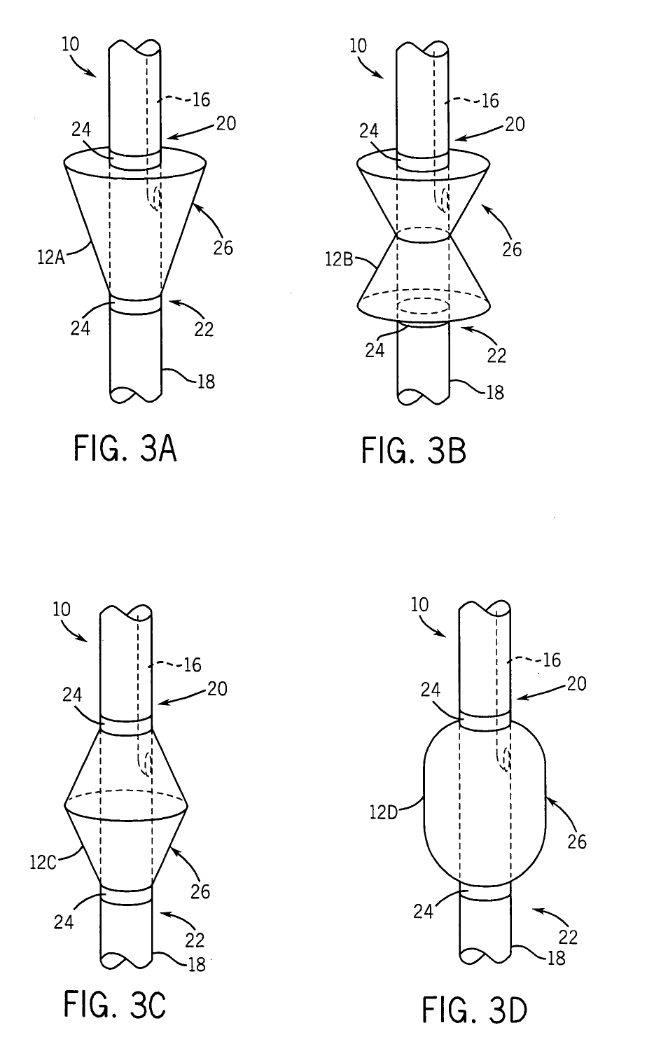

In various exemplary embodiments the inflatable cuff 12 may be shaped differently when inflated. For example, referring now to FIGS. 3A through 3D, various exemplary cuff shapes are depicted. FIG. 3A depicts an exemplary cuff 12A having an inverted cone shape when inflated. Likewise, FIG. 3B depicts an exemplary cuff 12B having a generally hourglass shape, i.e., two cones generally connected at their apexes, when inflated. Similarly, FIG. 3C depicts an exemplary cuff 12C wider at the middle than at the proximate and distal ends 20 and 22, but with generally straight walls connecting the middle and ends, i.e., two cones generally connected at their bases. Conversely, FIG. 3D depicts an exemplary cuff 12D wider at the middle than at the proximate and distal ends 20 and 22, but with generally straight or slightly curved walls throughout the middle of the cuff body 26. As will be appreciated by those of ordinary skill in the art, other cuff shapes having straight, curved walls, or combinations of straight and curved walls are possible and are within the scope of the present disclosure. Other cuff shapes and designs are discussed in the U.S. patent applications titled “ENDOTRACHEAL CUFF AND TECHNIQUE FOR USING THE SAME” to Donald S. Nelson and Dhairya Mehta filed on Jun. 22, 2006 and the U.S. patent application titled “ENDOTRACHEAL CUFF AND TECHNIQUE FOR USING THE SAME” to Seamus Maguire, Sean Morris, Paul O'Neill, and Patrick Joseph Tiernan filed on Jun. 22, 2006, which are hereby incorporated by reference in their entirety. The collar regions 24 adhering or otherwise attaching the various cuffs to the respective main tube bodies 18 are typically the same or about the same diameter as the main tube body 18.

The inflatable cuffs 12 discussed herein may be formed by various techniques. In one implementation of the present technique the inflatable cuff 12 is formed by blow-molding. In one example of such an implementation, a tubular polyurethane extrusion is blow-molded to form the cuff 12. The tubular extrusion has a suitable internal diameter and wall thickness such that, when the extrusion is blown, the resulting cuff 12 has a sufficient internal diameter to fit onto an endotracheal tube 10 and has the desired wall thickness.

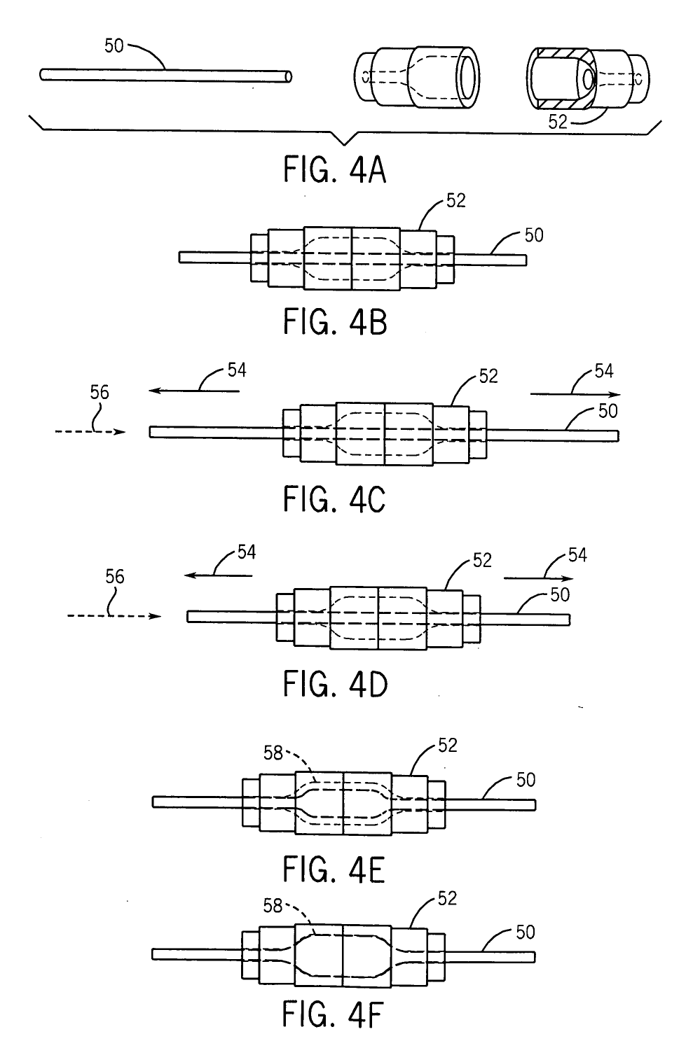

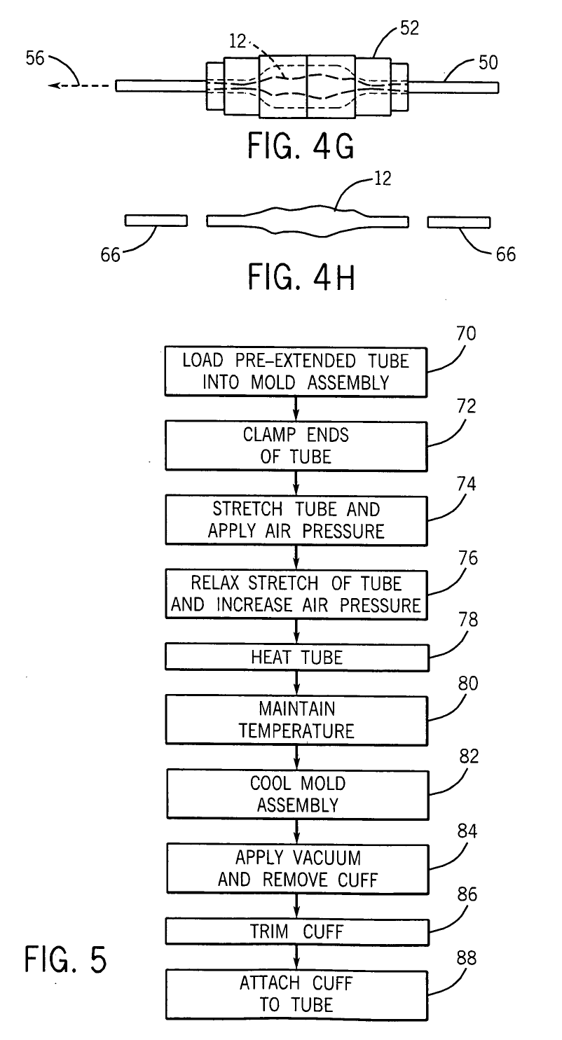

One example of such a blow molding process is depicted in FIGS. 4A-4H and in the flowchart of FIG. 5. Turning now to FIG. 4A, in this example, a tubular substrate 50, such as an extruded polyurethane tube, is loaded (block 70 of FIG. 5) into a blowing machine, such as a machine used to blow angioplasty balloons, or other suitable mold assembly 52. In one such an embodiment, the tubular substrate 50, such as a polyurethane tube, may be 11 to 12 inches (27.94 cm to 30.48 cm) in length with an internal diameter between 0.235 inches and 0.245 inches (5.969 mm to 6.223 mm) and a wall thickness between 0.008 inches and 0.012 inches (0.2032 mm to 0.3048 mm). As one of ordinary skill art will appreciate, the tubular substrate 50 may be formed from a material having suitable mechanical properties, such as sufficient puncture and/or tear resistance, at the desired wall thickness of the cuff 12. Examples of such materials include, but are not limited to polyurethane or polyurethane-based compositions, polymethylmethacrylate, polyacrylonitrile, polyamides (such as nylon), polycarbonate, polyesters (such as polyethylene terephthalate), polyolefins (such as polyethylenes and polypropylenes), polystyrene or vinyls (such as polyvinyl chloride and polyvinylacetate). A suitable blowing machine, such as an angioplasty balloon blowing machine, typically allow process parameters such as extrusion stretch, blow pressure, and temperature to be controlled.

In one implementation, the mold assembly 52 is closed (FIG. 4B) after the tubular substrate 50 is loaded and the tubular substrate 50 is clamped at each end (block 72 of FIG. 5). As depicted in FIG. 4C, the tubular substrate 50 is stretched (depicted by solid arrows 54) and air is blown into the tubular substrate 50 (depicted by dashed arrow 56) to achieve a desired positive pressure within the tubular substrate 50 (block 74 of FIG. 5). In one embodiment, the positive pressure within the tubular substrate 50 is 1.1-1.3 bars. Air may be blown into the tubular substrate 50 via an air conduit, such as an air hose or nozzle, connected to a source of pressurized air or inert gases, such as an air pump or pre-pressurized source. In one embodiment, depicted in FIG. 4D, the stretch of the tubular substrate 50 is decreased after the initial stretching operation and the air pressure within the tubular substrate 50 is increased to 1.4-1.6 bars (block 76 of FIG. 5). As one of ordinary skill in the art will appreciate, in other embodiments the degree to which the tubular substrate 50 is stretched may be unchanged or increased instead of being decreased.

In FIG. 4E, heat is applied to the tubular substrate 50 (block 78 of FIG. 5), such as via heating elements integral to the mold assembly 52, and a portion 58 of the tubular substrate 50 within the mold expands to fill the mold assembly 52. Once the desired temperature is reached it is maintained for an interval of time (block 80 of FIG. 5) during which the portion 58 of the tubular substrate 50 continues to expand to fill the mold, as depicted in FIG. 4F. For example, in one embodiment, the tubular substrate 50 is heated to a temperature greater than the glass transition temperature (T_{G}) and less than the melting point (T_{MP}) of the material from which the tubular substrate 50 is formed and the tubular substrate 50 is maintained at this temperature for 15 to 20 seconds.

Afterward, as depicted in FIG. 4G, the temperature of the mold assembly 52 is passively or actively cooled (block 82 of FIG. 5) and a vacuum is applied (depicted by dashed arrow 56) within the tubular substrate 50, which now includes the blown cuff 12, to release the tubular substrate 50 and cuff 12 from the mold assembly 52. For example, in one embodiment, the mold assembly 52 and cuff 12 are cooled to a temperature greater than 40° C. and less than the crystallization temperature (T_{C}) of the material from which the tubular substrate 50 is formed. The resulting cuff 12 has a wall thickness as described above, i.e., less than about 0.001 inches (0.0254 mm). In one embodiment, the cuff 12 may also be characterized as having an outer diameter of 1.05 to 1.1 inches (26.67 mm to 27.94 mm), for example, 1.08 inches (27.432 mm), when inflated at a pressure of 20 cm of H₂O.

The tubular substrate 50 and cuff 12 are removed from the mold assembly 52 (block 84 of FIG. 5). If needed, the cuff 12 may be trimmed (FIG. 4H)(block 86 of FIG. 5) to remove remaining extraneous portions 66 of the tubular substrate 50 which are not needed to secure the cuff 12 to an endotracheal tube 10 or other type of tracheal tube. The trimmed cuff 12 may then be attached (block 88 of FIG. 5) to a tube, such as endotracheal tube 10 of FIG. 1, for subsequent use on a patient. As will be appreciated by those of ordinary skill in the art, more than one cuff 12 may be formed at a time by the preceding technique. For example, a suitable mold assembly may provide for the production of multiple cuffs 12 from a single tubular substrate 50.

For example, in one particular implementation a commercially available extrusion of Dow Pellethane® 2363-90A having a length of 12 inches, an inner diameter of 0.239±0.005 inches (6.0706±0.127 mm) and a wall thickness of 0.008 inches (0.2032 mm) may be blown to form a cuff 12 having a wall thickness less than or equal to 0.001 inches (0.0254 mm) suitable for use with a 7.5 mm internal diameter (ID) endotracheal tube. In this example, the tubular extrusion is loaded into a mold assembly 52 of an angioplasty balloon blowing machine as described above. The mold assembly 52 is closed and the extruded tube is clamped or otherwise secured at each end. The extruded tube is stretched such that each end extends about 75 mm to about 85 mm from its initial position. A pressure of 1.1 to 1.3 bar is applied within the extruded tube. The degree to which each end of the tubular substrate 50 is stretched is decreased in the exemplary embodiment such that each end of the tubular substrate 50 extends about 60 mm to about 70 mm from its initial position and the air pressure within the extruded tube is increased to 1.5 to 1.6 bar. The temperature is increased to 125° C. to 135° C., where it is maintained for 15 to 20 seconds. The mold assembly 52 is then cooled to 45° C. to 55° C., a vacuum is applied to the molded extrusion and cuff, and the extrusion and cuff are removed from the mold assembly 52.

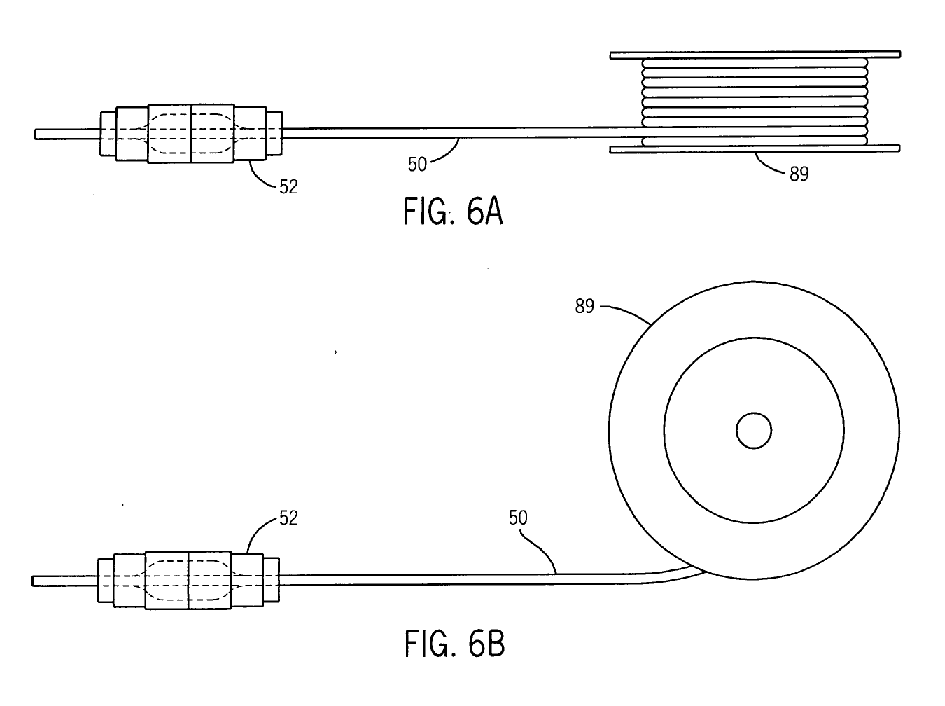

While the preceding discussion generally describes the use of a tubular substrate 50 as a discrete unit, one of ordinary skill in the art will appreciate that the tubular substrate 50 may be provided as a continuous length of tube, such as may be spooled and fed to the mold assembly as needed. For example, referring to FIGS. 6A and 6B, a spool 89 is depicted which is configured to feed a continuous length of tubular substrate 50 to a mold assembly 52 for processing as described above. In this manner, the processing of the tubular substrate 50 and the manufacture of cuffs 12 may be performed in a continuous or semi-continuous manner.

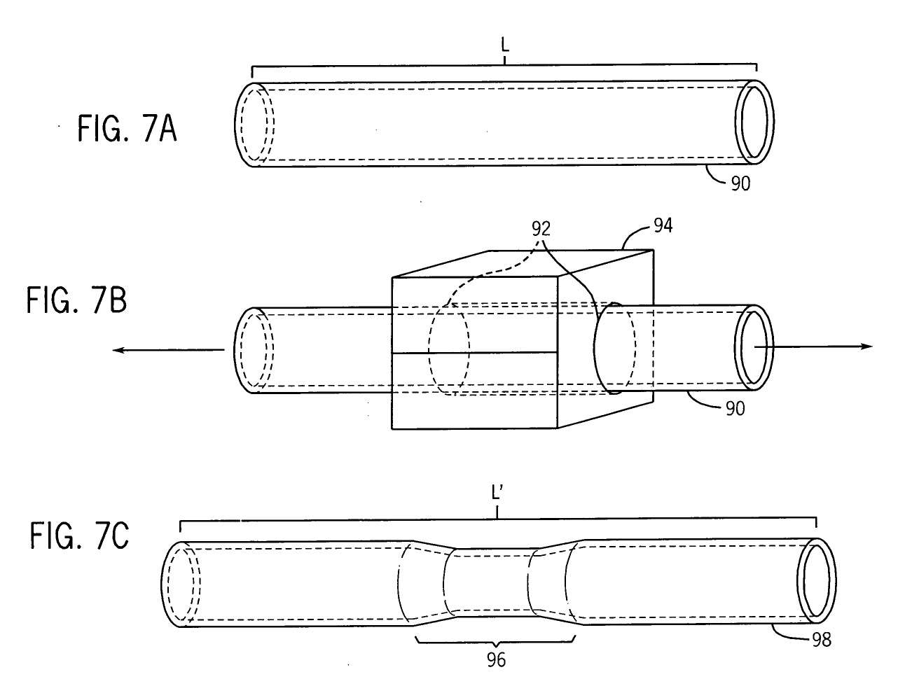

Referring now to FIG. 7, in other embodiments, a tubular substrate 90, such as an extruded polyurethane tube, is heated and stretched in a separate process, such as in a draw-down process, prior to being subjected to the blowing operation. In such embodiments, the tubular substrate 90, as depicted in FIG. 7A, may initially have thicker walls which are thinned by the draw-down process, i.e., the heating and stretching operations. For example, in one implementation of such an embodiment a tubular substrate 90 having a length (L) of 11 to 12 inches (27.94 cm to 30.48 cm), an internal diameter between 0.235 inches and 0.245 inches (5.969 mm to 6.223 mm), and a wall thickness between 0.008 inches and 0.012 inches (0.2032 mm to 0.3048 mm) is processed in such a draw-down process. In one embodiment, one or both ends of the tubular substrate 90 are clamped or otherwise secured. A section 92 of the tubular substrate 90 is heated to greater than T_{MP} for the tubular substrate 90, such as via the depicted heating element 94 (FIG. 7B). For example, in an embodiment where the tubular substrate 90 is formed of polyurethane, the tubular substrate may be heated to a temperature greater than about 180° C., such as to about 200° C. When the section 92 of the tubular substrate 90 is heated, one or both ends of the tubular substrate 90 are pulled (as depicted by the opposing force arrows of FIG. 7B) so that the extruded tube stretches, such as by a factor of two to three, due to the thinning of the tubular substrate 90 along the heated section 92, resulting in a thinned region 96 (FIG. 7C). For example, in an embodiment where the tubular substrate 90 has an initial wall thickness of about 0.008 inches (0.2032), the wall thickness along the section 92 may be from about 0.004 to 0.005 inches (0.101 6 mm to 0.127 mm) after the draw down process. As will be appreciated by those of ordinary skill in the art, the length of the section 92 to be heated and stretched may vary depending on the number of cuffs to be formed from the section 92. For example, in one embodiment where a single cuff is to be formed, the section 92 may be approximately 1 inch (25.4 mm). In other embodiments, the section 92 may range from 1 inch (25.4 mm) to about the entire length of the tubular substrate 90.

The stretching and heating steps may add tensile strength to the extruded tubular substrate 90 (such as due to changes in the orientation of polymers from which the tubular substrate 90 is formed) and may decrease the duration of the blowing operation described above. For example, a pre-heated and stretched tube 98 may be subjected to the heating and/or stretching processes described with regard to FIGS. 4 and 5 for a shorter duration or at a lower temperature than would be employed for a tubular substrate 50 that is heated or stretched immediately prior to the blowing-molding operation. For example, in one implementation, it is envisioned that the cuff 12 may be blown from a pre-heated and stretched tube 98 in the manner described with regard to FIG. 4 at a temperature between about 110° C. to about 120° C. Alternatively, the pre-heated and stretched tube 98 may be blow-molded as described above without being subjected to heating and stretching immediately prior to blow-molding. For example, in one implementation, it is envisioned that the cuff 12 may be blown from a pre-heated and stretched tube 98 at a temperature between the T_{G} and the T_{MP} of the tubular substrate material at a pressure between 1.4 and 1.6 bars without heating and stretching immediately prior to blowing. In such an implementation, a conventional blow molding apparatus may be employed, as opposed to an apparatus configured to perform the preliminary heating and stretching operations, such as the described balloon blowing machines.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims. Indeed, the present techniques may not only be applied to forming cuffs for tracheal tubes but for any type of device designed for insertion into a human or animal body for which a tight seal is desired.

What is claimed is:

1. A method of manufacturing an inflatable cuff, comprising:
stretching a tube;
creating a positive pressure within the tube;
changing the amount the tube is stretched;
heating the tube; and
increasing the positive pressure within the tube such that a portion of the tube is blown outward to form a cuff.

2. The method of claim 1, wherein changing the amount the tube is stretched comprises decreasing the stretch of the tube.

3. The method of claim 1, wherein changing the amount the tube is stretched comprises increasing the stretch of the tube.

4. The method of claim 1, wherein the tube comprises at least one of a polyurethane or polyurethane-based composition, a polymethylmethacrylate, a polyacrylonitrile, a polyamide, a polycarbonate, a polyester, a polyolefin, a polystyrene, or a vinyl.

5. The method of claim 1, wherein the tube comprises a material having a puncture resistance greater than 7 pounds of force/square inch at the desired wall thickness.

6. The method of claim 1, comprising loading the tube into a balloon blowing machine.

7. The method of claim 1, comprising loading the tube into a machine configured to blow angioplasty balloons.

8. The method of claim 1, comprising releasing the tube from a mold by applying a vacuum to the tube.

9. The method of claim 1, comprising removing one or more extraneous portions of the tube from the cuff.

10. The method of claim 1, comprising attaching the cuff to a tracheal tube.

11. The method of claim 1, wherein the cuff comprises walls that are about 0.001 inches (0.0254 mm) thick or less.

12. The method of claim 1, wherein the cuff comprises walls that are between about 0.0002 inches (0.00508 mm) thick and about 0.00015 inches (0.00381 mm) thick.

13. The method of claim 1, wherein the cuff comprises walls that are between about 0.001 inches (0.0254 mm) thick and about 0.0001 inches (0.00254 mm) thick.

14. The method of claim 1, wherein a composition from which the cuff and the tube are formed has a higher tensile strength after one or more of the acts of stretching or heating.

15. A method of forming a tube for use in a cuff-manufacturing process, comprising:
heating at least a section of a tube to at a temperature greater than the melting point of the tube;
stretching the tube in the direction of the main axis of the tube such that the section lengthens and thins; and
providing the stretched tube as a substrate for forming at least one inflatable cuff, wherein the inflatable cuffs are formed from the section of the tube.

16. The method of claim 15 wherein the temperature is greater than about 180° C.

17. The method of claim 15 wherein the temperature is about 200° C.

18. The method of claim 15, wherein the section comprises more than about 1 inch (25.4 mm) and less than the whole tube prior to heating.

19. The method of claim 15, comprising:
heating the tube; and
applying a positive pressure within the tube such that a portion of the tube is blown outward to form the inflatable cuff.

20. The method of claim 15, wherein the section has a higher tensile strength than the remainder of the tube after at least one of heating and stretching.

21. A method of manufacturing an inflatable cuff, comprising:
stretching a tube comprising a composition;
creating a positive pressure within the tube;
changing the amount the tube is stretched;
heating the tube; and
increasing the positive pressure within the tube such that a portion of the tube is blown outward to form a cuff comprising the composition, wherein the tensile strength of the composition is greater in the cuff than in the tube.

22. The method of claim 21, wherein the composition comprises at least one of a polyurethane or polyurethane-based composition, a polymethylmethacrylate, a polyacrylonitrile, a polyamide, a polycarbonate, a polyester, a polyolefin, a polystyrene, or a vinyl.

23. The method of claim 21, wherein the cuff has a puncture resistance greater than 7 pounds of force/square inch.

24. The method of claim 21, comprising loading the tube into a balloon blowing machine.

25. The method of claim 21, comprising loading the tube into a machine configured to blow angioplasty balloons.

26. The method of claim 21, comprising releasing the tube from a mold by applying a vacuum to the tube.

27. The method of claim 21, comprising removing one or more extraneous portions of the tube from the cuff.

28. The method of claim 21, comprising attaching the cuff to a tracheal tube.

29. The method of claim 21, wherein the cuff comprises walls that are about 0.001 inches (0.0254 mm) thick or less.

30. The method of claim 21, wherein the cuff comprises walls that are between about 0.0002 inches (0.00508 mm) thick and about 0.00015 inches (0.00381 mm) thick.

31. The method of claim 21, wherein the cuff comprises walls that are between about 0.001 inches (0.0254 mm) thick and about 0.0001 inches (0.00254 mm) thick.
